(19) United States
(12) Patent Application Publication
(10) Pub. No.: US 2020/0134739 A1
(43) Pub. Date: Apr. 30, 2020

(54) APPARATUS AND METHOD FOR SOLICITING DYNAMIC GROUP SUPPORT FOR AN INDIVIDUAL VIDEO STREAMING AN EVENT

(71) Applicant: AMI Holdings Limited, Hamilton (BM)

(72) Inventor: Liubov VYAZNIKOVA, Hamilton (BM)

(73) Assignee: AMI Holdings Limited

(21) Appl. No.: 16/175,527

(22) Filed: Oct. 30, 2018

(51) Int. Cl. G06Q 50/00; G07C 13/00; H04N 21/4788; H04N 21/81

(52) U.S. Cl. CPC G06Q 50/01; H04N 21/8146; H04N 21/4788; G07C 13/00

(57) ABSTRACT

A computer implemented method includes receiving from a client device, via a network, a description of a social media event. The description of the social media event specifies a video streaming event and support required to initiate the social media event. The description of the social media event is broadcasted via the network to client devices. Support pledges from the client devices are collected via the network. Final event details are established after the support required to initiate the social media event is received. The final event details are broadcasted via the network to the client devices. The social media event is received from the client device via the network. The social media event is broadcasted via the network to the client devices. A dynamic leader board characterizing individuals generating the largest support for the social media event is supplied.

### FIELD OF THE INVENTION

This invention relates generally to social media applications deployed in computer networks. More particularly, this invention is directed toward techniques for soliciting dynamic group support for an individual video streaming an event.

### BACKGROUND OF THE INVENTION

Operators of social media applications, such as social network applications (e.g., Facebook®, Twitter®) and dating applications (e.g., Bumble®, Badoo®) are always interested in heightened user engagement. Users of social media applications are typically interested in entertaining their followers. Thus, it would be desirable to develop techniques for heightened user engagement and entertaining followers in a social media application.

### SUMMARY OF THE INVENTION

A computer implemented method includes receiving from a client device, via a network, a description of a social media event. The description of the social media event specifies a video streaming event and support required to initiate the social media event. The description of the social media event is broadcasted via the network to client devices. Support pledges from the client devices are collected via the network. Final event details are established after the support required to initiate the social media event is received. The final event details are broadcasted via the network to the client devices. The social media event is received from the client device via the network. The social media event is broadcasted via the network to the client devices. A dynamic leader board characterizing individuals generating the largest support for the social media event is supplied.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations performed in accordance with an embodiment of the invention.

FIG. 3 illustrates a user interface configured in accordance with an embodiment of the invention.

Like reference numerals refer to corresponding parts throughout the several views of the drawings.

### DETAILED DESCRIPTION OF THE INVENTION

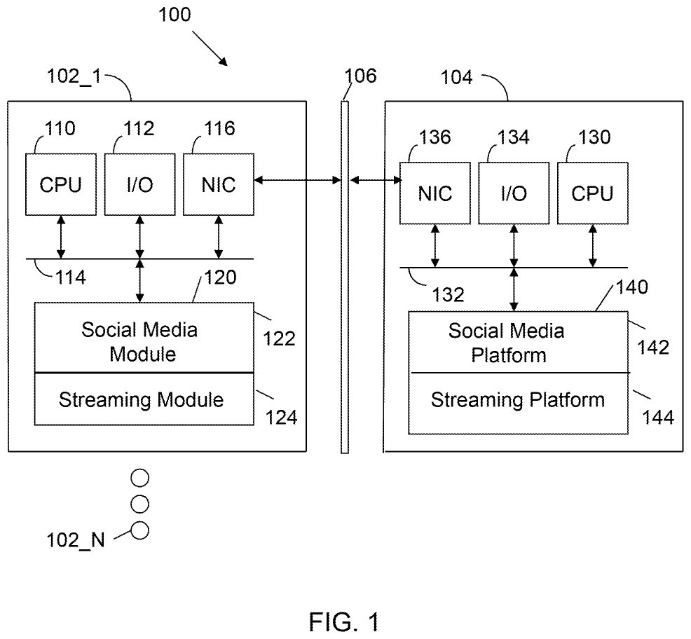

FIG. 1 illustrates a system 100 configured in accordance with an embodiment of the invention. The system 100 includes a set of client devices 102_1 through 102_N in communication with a server 104 via a network 106, which may be any combination of wired and wireless networks. Each client device 102 includes a processor (e.g., central processing unit) 110 in communication with input/output devices 112 via a bus 114. The input/output devices 112 may include a keyboard, mouse, touch display and the like. A network interface circuit 116 is also connected to the bus 114 to provide connectivity to network 106.

A memory 120 is also connected to the bus 114. The memory 120 stores instructions executed by the processor 110. In particular, the memory 120 stores a social media module 122. The social media module 122 may be any client side application that implements social media operations. Social media operations are defined as any application that facilitates communications between users communicating over a computer network. The social media operations may be associated with a social network (e.g., Facebook®, YouTube®, Instagram®, Twitter®, Snapchat®, Pinterest®) and/or dating application (e.g., Bumble®, Badoo®).

The memory 120 also stores a streaming module 124. In one embodiment, the streaming module 124 implements the Real-time Transport Protocol (RTP) to deliver audio and video over Internet Protocol (IP) networks. Thus, each client device can be used to stream audio and video.

Typically, each client device 102_1 through 102N is a mobile device executing the social media module 122 and streaming module 124. Different client devices 102_1 through 102_N are operated by different individuals that subscribe to the same social media application.

Server 104 includes standard components, such as a processor 130, bus 132, input/output devices 134 and a network interface circuit 136 to provide connectivity to network 106. A memory 140 is connected to the bus 132. The memory 140 stores a social media platform 142. The social media platform 142 may implement any type of social media operation. The memory 140 also stores a streaming platform 144. The streaming platform 144 is configured to accept a streamed event from one client device (e.g., 102_1) and broadcast it to other client devices (e.g., 102_2 through 102_N). Alternately, the streaming platform coordinates peer-to-peer broadcast of a streamed event from one client device to other client devices.

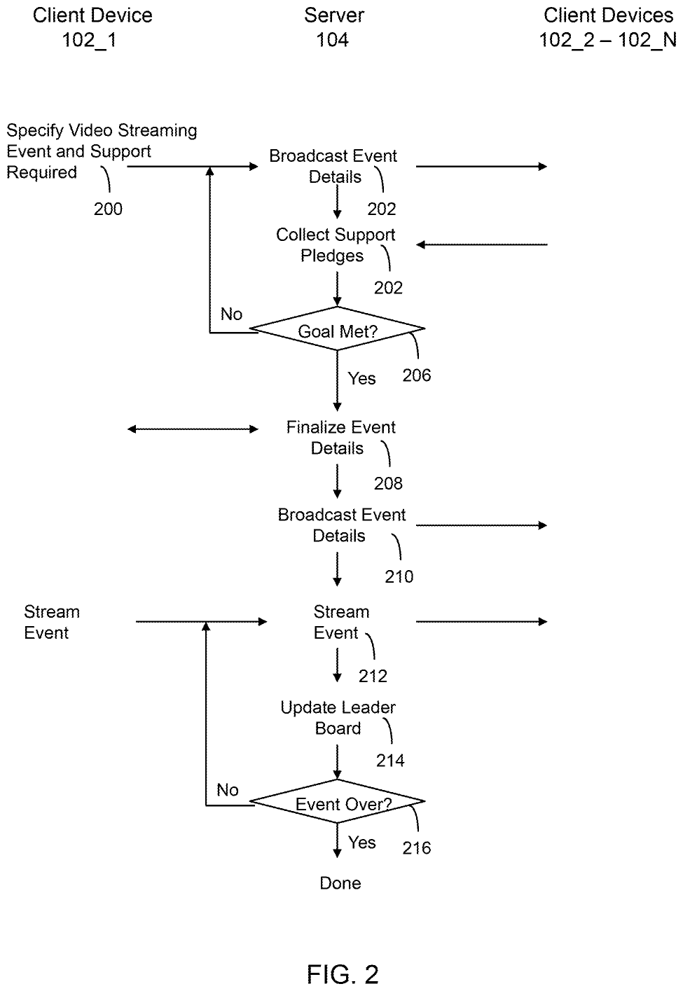

FIG. 2 illustrates operations performed in accordance with an embodiment of the invention. In particular, the figure illustrates operations performed by server 104 in connection with a client device 102_1, used by an individual organizing and broadcasting a social media event, and client devices 102_2 through 102_N, which are recipients of the social media event. The social media module 122 provides prompts to the individual organizing the social media event. The prompts have the individual specify a description of the social media event 200. The description of the social media event specifies a video streaming event and support required to initiate the social media event. For example, the individual may specify that she will video stream herself bungee cord jumping if support in the form of a 100 followers for the event is generated. As used herein, “support” refers to assistance to the individual streaming the event, which may be in the form of following the streaming event, a pledge of consideration (e.g., a hard currency, a virtual currency), securing new followers for the individual streaming the event and the like.

The social media event information 200 is conveyed over network 106 to server 104, which broadcasts event details 202 to a plurality of client devices 102_2 through 102N, which may be associated with an existing social network of the individual using client device 102_1 or may be associated with a larger audience currently unknown to the individual using the client device 102_1. Support pledges are collected 202 from the client devices 102_2 through 102_N. It is then determined whether the goal of the required support is met 206. If so (206—Yes), the event details are finalized 208. This may be accomplished programmatically by the server 104 operating alone, e.g., setting a date, time, broadcast link, etc., or the server 104 communicating with the client device 102_1. The event details are then broadcasted 210 to the client devices 102_2 through 102_N.

At the specified date and time, the user associated with the client device 102_1 streams an event. Server 104 broadcasts the stream 212 to the client devices 102_2 through 102_N. The server 104 may operate as a hub for the broadcast or may coordinate peer-to-peer broadcast of the event. The streaming platform 144 may be a separate machine than the machine hosting the social media platform 142.

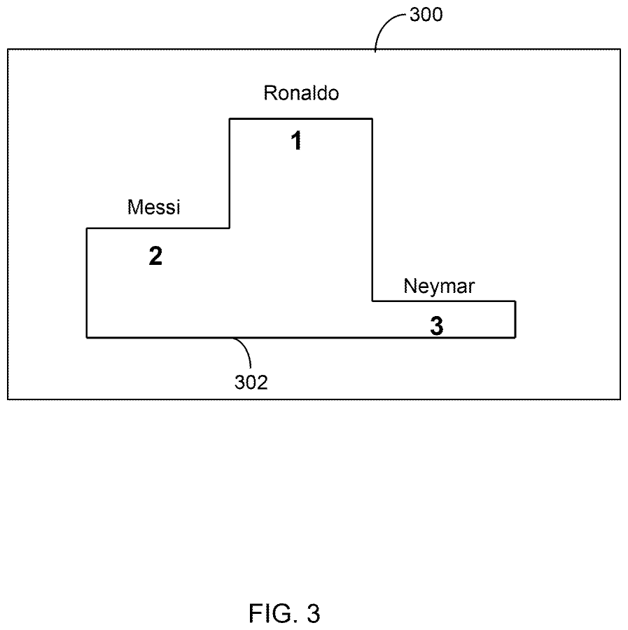

During the event, a leader board is presented. The leader board lists individuals that have generated the largest support for the social media event. FIG. 3 illustrates an interface 300 with an exemplary leader board 302. The leader board is dynamically updated 214 during the event. It is determined whether the event is over 216. If not (216—No), control returns to block 212. If so (216—Yes), processing is completed.

Thus, for an entity that hosts a social media platform, the disclosed technology heightens user engagement. The disclosed technology also allow a user to entertain followers, while obtaining support from followers.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising:
receiving from a client device, via a network, a description of a social media event, wherein the description of the social media event specifies a video streaming event and support required to initiate the social media event;
broadcasting, via the network, the description of the social media event to a plurality of client devices;
collecting, via the network, support pledges from the plurality of client devices;
establishing final event details after the support required to initiate the social media event is received;
broadcasting, via the network, the final event details to the plurality of client devices;
receiving, from the client device via the network, the social media event;
broadcasting, via the network, the social media event to the plurality of client devices; and
supplying a dynamic leader board characterizing individuals generating the largest support for the social media event.
